(19) United States
(12) Patent Application Publication
(10) Pub. No.: US 2025/0217715 A1
(43) Pub. Date: Jul. 3, 2025

(54) SMART PROMPT GENERATOR FOR GPT MODELS

(71) Applicant: MICROSOFT TECHNOLOGY LICENSING, LLC, Redmond, WA (US)

(72) Inventors: Steven Rhejohn Barlin SO, Burlington, MA (US); Tasneem Khuzema NASEEM, Cambridge, MA (US); Muhammad Umair AFZAL, Abbotsford (CA); Sarim Mohammed AHMED, Burlington, MA (US); Alina ZHENG, Newton, MA (US); Philip TO, Lexington, MA (US); Andrew Scott BROOKS, Northborough, MA (US)

(21) Appl. No.: 18/400,535

(22) Filed: Dec. 29, 2023

(51) Int. Cl. G06N 20/10

(52) U.S. Cl. CPC G06N 20/10

(57) ABSTRACT

Conditions are identified in a telecommunications network based on data collected from the telecommunications network. A first artificial intelligence (AI) model is used to identify a network function (NF) type. Based on the NF type, a second AI model is used to generate a prompt for a generative pre-trained transformer (GPT) model. The prompt is input to the GPT model to identify a condition in the telecommunications network.

### BACKGROUND

A cloud network providing mobile communications services can have thousands or millions of nodes such as servers and other devices running various networking functions. The nodes and networking functions collectively need to operate reliably in order to provide high-performance services. It is therefore important to provide an effective monitoring mechanism to detect anomalies early, take corrective action, and track each node and network function over its lifecycle to maintain network health and avoid downtime. In a cloud-based system (e.g., one or more data centers) that includes thousands or millions of nodes, the inability to maintain node health and serviceability can have consequences such as processing delays and increased costs, which otherwise can lead to revenue loss and customer dissatisfaction.

It is with respect to these considerations and others that the disclosure made herein is presented.

### SUMMARY

Methods and systems are disclosed for implementing a smart prompt generator that collects telemetry data such as logs, events, traces, and metrics in a development/production environment. The smart prompt generator uses artificial intelligence (AI) to intelligently identify network function (NF) types and extract relevant information from collected data to create a customized prompt that is sent to a generative pre-trained transformer (GPT) model that is configured to identify the root cause of errors and provide remediation recommendations.

This Summary is not intended to limit the scope of the claimed subject matter. Furthermore, the claimed subject matter is not limited to implementations that solve any or all disadvantages noted in any part of this disclosure.

### DRAWINGS

The Detailed Description is described with reference to the accompanying FIGS. In the FIGS., the left-most digit(s) of a reference number identifies the FIG. in which the reference number first appears. The same reference numbers in different FIGS. indicate similar or identical items.

FIG. 1 is a diagram illustrating the disclosed techniques according to one embodiment disclosed herein.

FIG. 2A is a diagram illustrating an example architecture according to one embodiment disclosed herein.

FIG. 2B is a diagram illustrating an example architecture according to one embodiment disclosed herein.

FIG. 2C is a diagram illustrating an example architecture according to one embodiment disclosed herein.

FIG. 3 is a diagram showing aspects of an example system according to one embodiment disclosed herein.

FIG. 4 is a diagram showing aspects of an example system according to one embodiment disclosed herein.

FIG. 5 is a flow diagram showing aspects of an illustrative routine, according to one embodiment disclosed herein.

FIG. 6 is a computer architecture diagram illustrating aspects of an example computer architecture for a computer capable of executing the software components described herein.

FIG. 7 is a data architecture diagram showing an illustrative example of a computer environment.

### DETAILED DESCRIPTION

A cloud network providing mobile communications services can have thousands or millions of nodes such as servers and other devices running various networking functions. The nodes and networking functions collectively need to operate reliably in order to provide high-performance services. The inability to maintain node health and serviceability can have consequences such as processing delays, increased costs, and frustrated customers.

The present disclosure describes methods and systems for implementing a smart prompt generator that collects 3rd Generation Partnership Project (3GPP) telemetry data, such as logs, events, traces, and metrics in a development/production environment. The smart prompt generator uses artificial intelligence (AI) to intelligently identify network function (NF) types and extract relevant information from collected data to create a customized prompt that is sent to a generative pre-trained transformer (GPT) model that is configured to identify the root cause of errors and provide remediation recommendations.

Referring to the appended drawings, in which like numerals represent like elements throughout the several FIGURES, aspects of various technologies for generating and using prompts will be described. In the following detailed description, references are made to the accompanying drawings that form a part hereof, and which are shown by way of illustration specific configurations or examples.

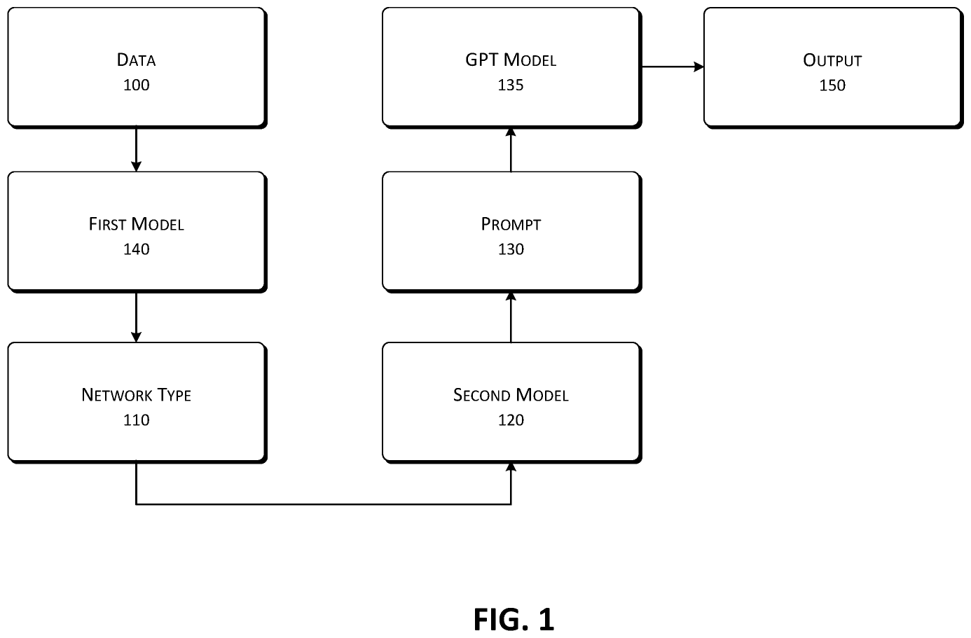

With reference to FIG. 1, illustrated is an example system for identifying conditions in a virtualized computing environment providing a telecommunications network running a plurality of network functions. The conditions can include root causes of issues and problems in the telecommunications network such as outages, problematic latencies, dropped data, and the like. The output of the system can also include recommendations for remediation of the identified conditions. In an embodiment, a computing system receives data 100 collected from the telecommunications network. The data 100 comprises test data from tests run in the telecommunications network or live production data from the telecommunications network. Based on the collected data 100, a first artificial intelligence (AI) model 140 is used to identify a network function (NF) type 110. Based on the NF type 100, a second AI model 120 is used to generate a prompt 130 for a generative pre-trained transformer (GPT) model 135. The prompt 130 is input to the GPT model 135 to identify and output 150 a condition in the telecommunications network. The condition is related to the NF type The GPT model 135 is trained with 3GPP documentation which provides telecommunications design and requirements knowledge to the GPT model. The GPT model is trained to perform root cause analysis and generate recommendations related to performance and system functionality in the telecommunications network. In an embodiment, an action is initiated at the telecommunications network based on the identified condition in the output 150.

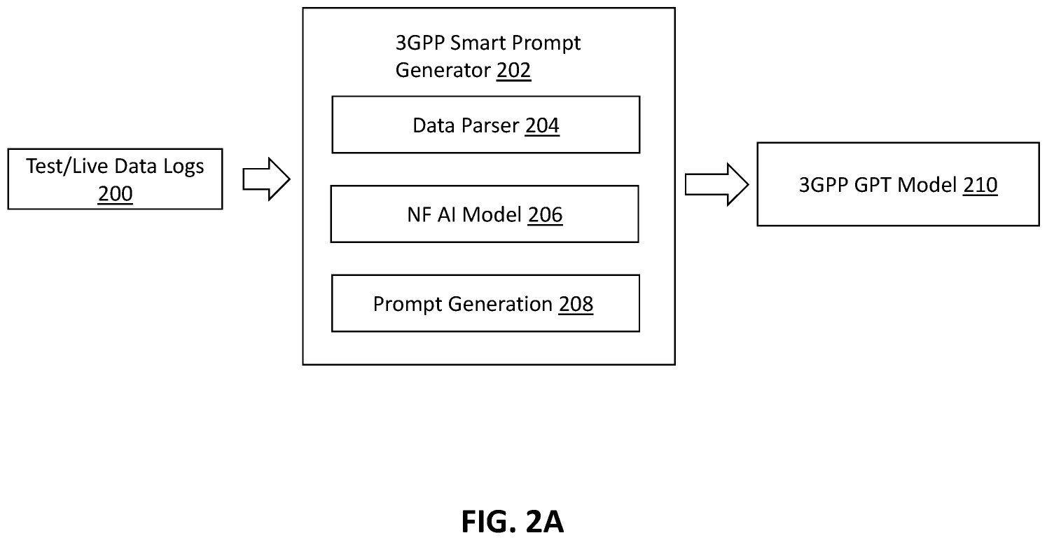

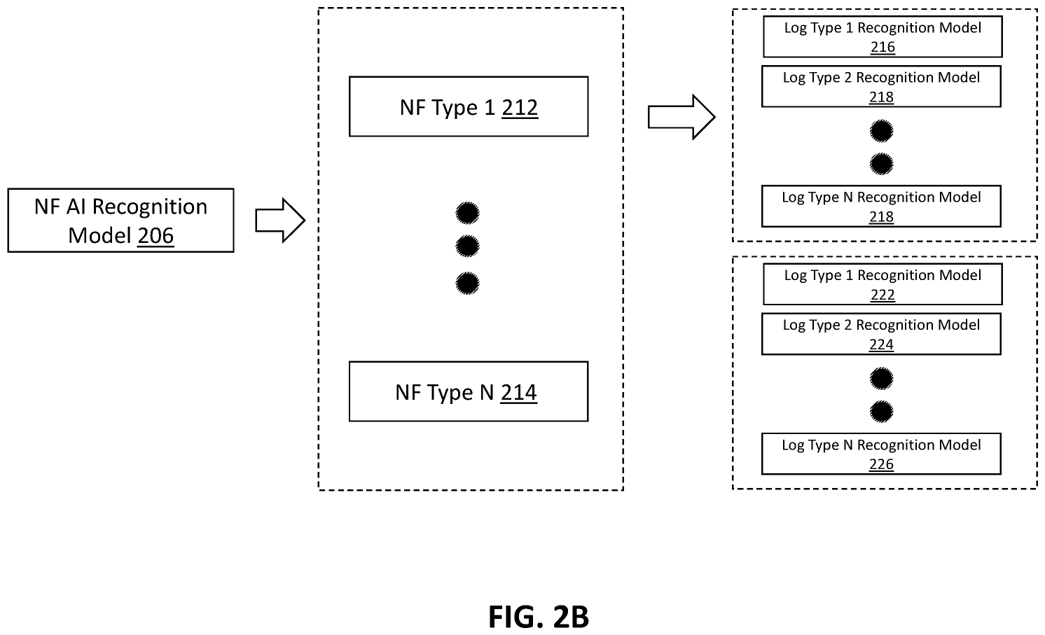

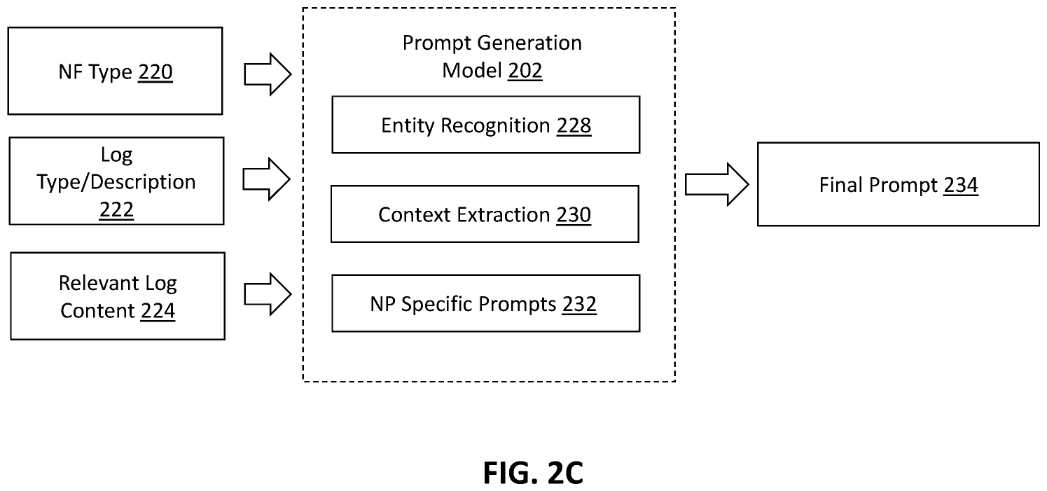

With reference to FIG. 2A, test/live data 200 comprises raw data collected from tests run in development or from live production environments and can include data such as metadata and telemetry data. Some examples can include throughput per user, event log data, memory usage, and the like. At data parser 202 of the 3GPP smart prompt generator 202, the raw data 200 is parsed, cleaned, and organized in a machine-readable structured format. In some embodiments, tables are concatenated to spatially map data with each other. For example, each datapoint can be mapped with the appropriate time intervals.

An NF AI model 206 uses AI to identify NF types and relevant telemetry information such as events, metadata, tags, error messages and metrics that will be used to curate the prompt. The NF AI model 206 can be a classification model, examples of which can include decision trees, K-nearest neighbor, multi-class support vector machine (SVM), and convolutional neural networks.

The output from the NF AI model 206 is received to generate NF specific prompts as illustrated by GPT model prompt generation 208. The prompt generation model 208 can be based on natural language processing (NLP) models.

In an embodiment, the 3GPP GPT model 210 is a GPT large language model that is trained with 3GPP specification documents to provide telecommunication design and requirement knowledge. 3GPP GPT model 210 can be used to perform root cause analysis and provide insights on performance and system functionality.

With reference to FIG. 2B, the network function (NF) recognition model 206 is configured to use natural language processing (NLP) techniques such as a Named Entity Recognition (NER) model that can be trained with datasets of NF names and their descriptions. The recognition model 206 is configured to recognize patterns that are associated with different types of network functions such as Mobility Management Entity (MME), user plane function (UPF), Session Management Function (SMF), Packet Data Network Gateway (PGW), Serving Gateway (SGW), etc. Once trained, the model 206 can be used to identify network functions from new log entries.

For NF Type 1 212 identified by the NF recognition model 206, for n types of log data (such as jaeger traces, pcaps, pod logs, csv) a log type recognition model is used to extract relevant log information.

For NF type N 214, for each NF type n, n log type recognition models are created to extract log information that will be used to customize the prompts to the GPT model. n log type recognition models are used as each NF may have a different log structure and each recognition model can be optimized to extract the most relevant information for each log type.

For the log type 1 recognition model 226, for a given log type such as a jaeger trace, NER can be used to extract network addresses, session identifiers, protocol specific information such as HTTP headers, DNS queries, or SIP messages and error messages. This can be combined with topic modeling that is used to identify patterns and trends in log data such as HTTP headers associated with certain operation names (e.g., Packet Forwarding Control Protocol (PFCP) Session Establishment Request)

For the log type 2 recognition model 218, for log types such as PCAP, a machine learning model is trained to classify network traffic as either benign or malicious based on features such as packet size, packet timing, and protocol type.

For the log type N recognition model (210), for each log type n, a recognition model is created that is trained with the structures, formats, and patterns contained in each log.

With reference to FIG. 2C, the prompt generation model 202 is configured to curate prompts based on the information extracted from the NF AI model that will be sent to the 3GPP GPT Model. In one embodiment, the prompt generation model 202 has three inputs:
NF type 220, which is the NF type identified by the NF AI model.
Log type 222, for each NF type, log types and associated description, and tags related to the logs.
Relevant log content 224, which is the context extracted from the recognition model for each log type.

In the prompt generation model 202, creation of the prompt includes specifying the NF type (e.g., SMF, UPF, AMF) by entity recognition 228. In the context extraction component 230, the prompt is appended with the context extracted from the recognition models. Additional weight-based techniques can be applied to truncate noise from the data in order to summarize prompts and optimize query costs.

Finally, domain knowledge in telecommunications and 3GPP standards is used to generate prompts at NF specific prompts 232. The specific prompts are tested to improve the accuracy of the results obtained from the GPT model.

In one embodiment, the final prompt 234 that will be sent to the GPT model is created by concatenating information from entity recognition 228, context extraction 230, and NF specific prompts 232. In other embodiments, the information can be combined or merged in other ways such as intelligently merging the information using, for example, an additional AI model.

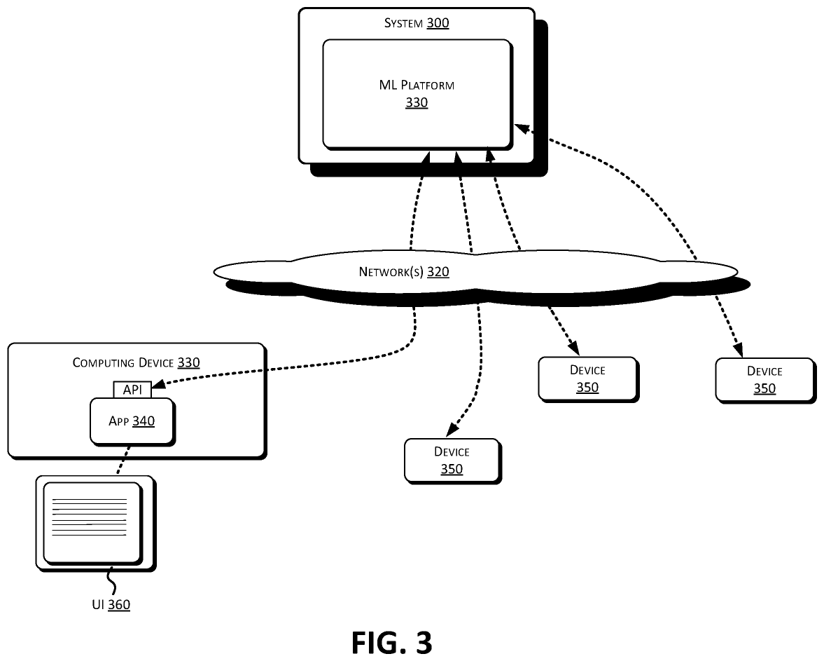

In various embodiments, the machine learning model(s) may be run locally on the client. In other embodiments, the machine learning inferencing can be performed on a server of a network. For example, in the system illustrated in FIG. 3, a system 300 is illustrated that implements ML platform 330. The ML platform 330 may be configured to provide output data to various devices 350 over a network 320, as well as computing device 330. A user interface 360 may be rendered on computing device 330. The user interface 360 may be provided in conjunction with an application 340 that communicates to the ML platform 330 using an API via network 320. In some embodiments, system 300 may be configured to provide issue identification information to users. In one example, ML platform 330 may implement a machine learning system to perform one or more tasks. The ML platform 330 utilizes the machine learning system to perform tasks such as root cause identification. The machine learning system may be configured to be optimized using the techniques described herein.

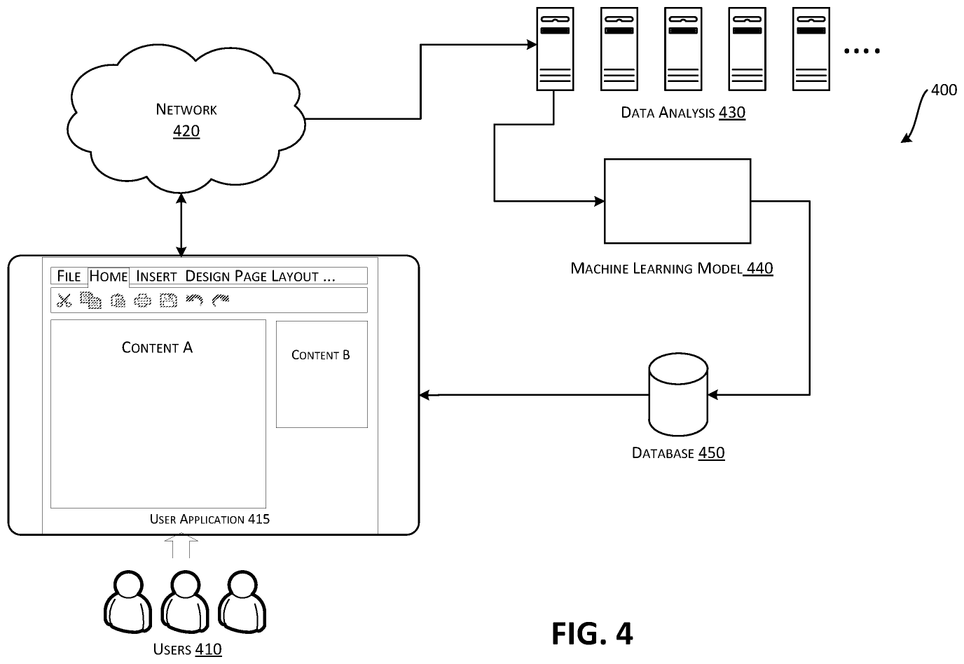

FIG. 4 is a computing system architecture diagram showing an overview of a system disclosed herein for implementing a machine learning model, according to one embodiment disclosed herein. As shown in FIG. 4, a machine learning system 400 may be configured to perform analysis and perform identification, prediction, or other functions based upon various data collected by and processed by data analysis components 430 (which might be referred to individually as an “data analysis component 430” or collectively as the “data analysis components 430”). The data analysis components 430 may, for example, include, but are not limited to, physical computing devices such as server computers or other types of hosts, associated hardware components (e.g., memory and mass storage devices), and networking components (e.g., routers, switches, and cables). The data analysis components 430 can also include software, such as operating systems, applications, and containers, network services, virtual components, such as virtual disks, virtual networks, and virtual machines. Database 450 can include data, such as a database, or a database shard (i.e., a partition of a database). Feedback may be used to further update various parameters that are used by machine learning model 420. Data may be provided to the user application 415 to provide results to various users 410 using a user application 415. In some configurations, machine learning model 420 may be configured to utilize supervised and/or unsupervised machine learning technologies. A model compression framework based on sparsity-inducing regularization optimization as disclosed herein can reduce the amount of data that needs to be processed in such systems and applications. Effective model compression when processing iterations over large amounts of data may provide improved latencies for a number of applications that use such technologies, such as image and sound recognition, recommendation systems, and image analysis.

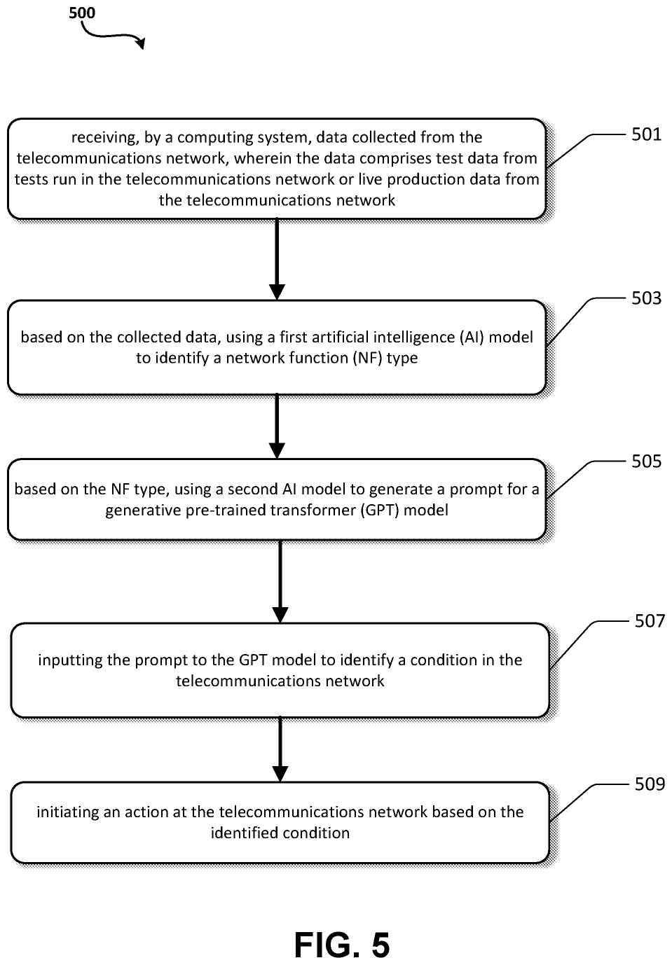

Turning now to FIG. 5, illustrated is an example operational procedure for identifying conditions in a virtualized computing environment providing a telecommunications network running a plurality of network functions in accordance with the present disclosure. The operational procedure may be implemented in a system comprising one or more computing devices.

It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a computing device, it can be appreciated that this routine can be performed on any computing system which may include a number of computers working in concert to perform the operations disclosed herein.

Thus, it should be appreciated that the logical operations described herein are implemented (1) as a sequence of computer implemented acts or program modules running on a computing system such as those described herein and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

Referring to FIG. 5, operation 501 illustrates receiving, by a computing system, data collected from the telecommunications network, wherein the data comprises test data from tests run in the telecommunications network or live production data from the telecommunications network.

Operation 503 illustrates based on the collected data, using a first artificial intelligence (AI) model to identify a network function (NF) type.

Operation 505 illustrates based on the NF type, using a second AI model to generate a prompt for a generative pre-trained transformer (GPT) model.

Operation 507 illustrates inputting the prompt to the GPT model to identify a condition in the telecommunications network, the condition related to the NF type. In an embodiment, the GPT model is trained with 3rd Generation Partnership Project (3GPP) documentation to provide telecommunications design and requirements knowledge to perform root cause analysis and generate recommendations related to performance and system functionality in the telecommunications network.

Operation 509 illustrates initiating an action at the telecommunications network based on the identified condition.

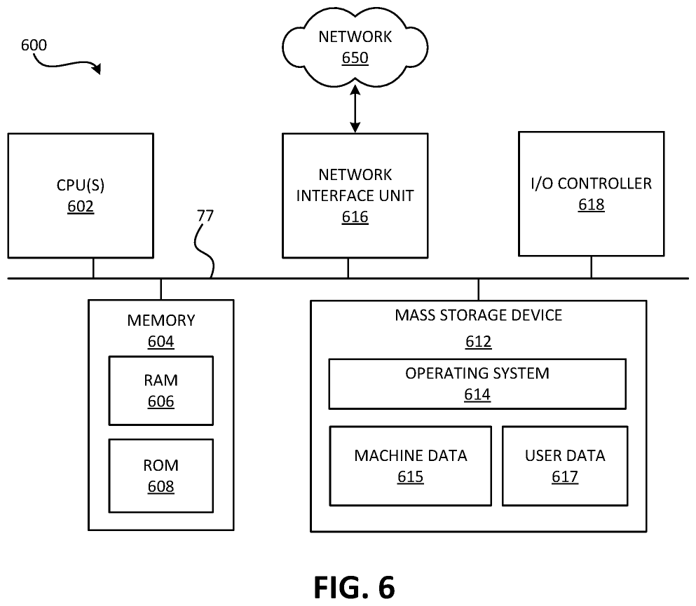

FIG. 6 shows an example computer architecture for a computer capable of providing the functionality described herein such as, for example, a computing device configured to implement the functionality described above with reference to FIGS. 1-6. Thus, the computer architecture 600 illustrated in FIG. 6 illustrates an architecture for a server computer or another type of computing device suitable for implementing the functionality described herein. The computer architecture 600 might be utilized to execute the various software components presented herein to implement the disclosed technologies.

The computer architecture 600 illustrated in FIG. 6 includes a central processing unit 602 (“CPU”), a system memory 604, including a random-access memory 606 (“RAM”) and a read-only memory (“ROM”) 608, and a system bus 77 that couples the memory 604 to the CPU 602. A firmware containing basic routines that help to transfer information between elements within the computer architecture 600, such as during startup, is stored in the ROM 608. The computer architecture 600 further includes a mass storage device 612 for storing an operating system 614, other data, such as product data 615 or user data 617.

The mass storage device 612 is connected to the CPU 602 through a mass storage controller (not shown) connected to the bus 77. The mass storage device 612 and its associated computer-readable media provide non-volatile storage for the computer architecture 600. Although the description of computer-readable media contained herein refers to a mass storage device, such as a solid-state drive, a hard disk or optical drive, it should be appreciated by those skilled in the art that computer-readable media can be any available computer storage media or communication media that can be accessed by the computer architecture 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer-readable media.

By way of example, and not limitation, computer-readable storage media might include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 600. For purposes of the claims, the phrase “computer storage medium,” “computer-readable storage medium” and variations thereof, does not include waves, signals, and/or other transitory and/or intangible communication media, per se.

According to various implementations, the computer architecture 600 might operate in a networked environment using logical connections to remote computers through a network 650 and/or another network (not shown). A computing device implementing the computer architecture 600 might connect to the network 650 through a network interface unit 616 connected to the bus 77. It should be appreciated that the network interface unit 616 might also be utilized to connect to other types of networks and remote computer systems.

The computer architecture 600 might also include an input/output controller 618 for receiving and processing input from a number of other devices, including a keyboard, mouse, or electronic stylus (not shown in FIG. 6). Similarly, the input/output controller 618 might provide output to a display screen, a printer, or other type of output device (also not shown in FIG. 6).

It should be appreciated that the software components described herein might, when loaded into the CPU 602 and executed, transform the CPU 602 and the overall computer architecture 600 from a general-purpose computing system into a special-purpose computing system customized to facilitate the functionality presented herein. The CPU 602 might be constructed from any number of transistors or other discrete circuit elements, which might individually or collectively assume any number of states. More specifically, the CPU 602 might operate as a finite-state machine, in response to executable instructions contained within the software modules disclosed herein. These computer-executable instructions might transform the CPU 602 by specifying how the CPU 602 transitions between states, thereby transforming the transistors or other discrete hardware elements constituting the CPU 602.

Encoding the software modules presented herein might also transform the physical structure of the computer-readable media presented herein. The specific transformation of physical structure might depend on various factors, in different implementations of this description. Examples of such factors might include, but are not limited to, the technology used to implement the computer-readable media, whether the computer-readable media is characterized as primary or secondary storage, and the like. If the computer-readable media is implemented as semiconductor-based memory, the software disclosed herein might be encoded on the computer-readable media by transforming the physical state of the semiconductor memory. For example, the software might transform the state of transistors, capacitors, or other discrete circuit elements constituting the semiconductor memory. The software might also transform the physical state of such components in order to store data thereupon.

As another example, the computer-readable media disclosed herein might be implemented using magnetic or optical technology. In such implementations, the software presented herein might transform the physical state of magnetic or optical media, when the software is encoded therein. These transformations might include altering the magnetic characteristics of locations within given magnetic media. These transformations might also include altering the physical features or characteristics of locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 600 in order to store and execute the software components presented herein. It also should be appreciated that the computer architecture 600 might include other types of computing devices, including hand-held computers, embedded computer systems, personal digital assistants, and other types of computing devices known to those skilled in the art.

It is also contemplated that the computer architecture 600 might not include all of the components shown in FIG. 6, might include other components that are not explicitly shown in FIG. 6, or might utilize an architecture completely different than that shown in FIG. 6. For example, and without limitation, the technologies disclosed herein can be utilized with multiple CPUS for improved performance through parallelization, graphics processing units (“GPUs”) for faster computation, and/or tensor processing units (“TPUs”). The term “processor” as used herein encompasses CPUs, GPUs, TPUs, and other types of processors.

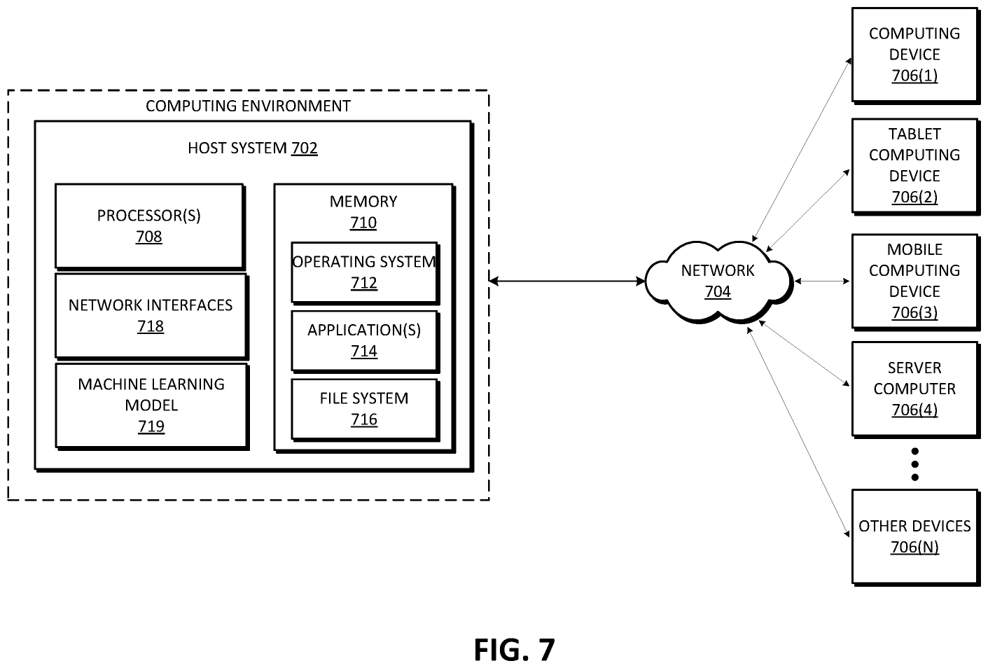

FIG. 7 illustrates an example computing environment capable of executing the techniques and processes described above with respect to FIGS. 1-6. In various examples, the computing environment comprises a host system 702. In various examples, the host system 702 operates on, in communication with, or as part of a network 704.

The network 704 can be or can include various access networks. For example, one or more client devices 706(1) . . . 706(N) can communicate with the host system 702 via the network 704 and/or other connections. The host system 702 and/or client devices can include, but are not limited to, any one of a variety of devices, including portable devices or stationary devices such as a server computer, a smart phone, a mobile phone, a personal digital assistant (PDA), an electronic book device, a laptop computer, a desktop computer, a tablet computer, a portable computer, a gaming console, a personal media player device, or any other electronic device.

According to various implementations, the functionality of the host system 702 can be provided by one or more servers that are executing as part of, or in communication with, the network 704. A server can host various services, virtual machines, portals, and/or other resources. For example, a can host or provide access to one or more portals, Web sites, and/or other information.

The host system 702 can include processor(s) 708 memory 710. The memory 710 can comprise an operating system 712, application(s) 714, and/or a file system 716. Moreover, the memory 710 can comprise the storage unit(s) 82 described above with respect to FIGS. 1-5.

The processor(s) 708 can be a single processing unit or a number of units, each of which could include multiple different processing units. The processor(s) can include a microprocessor, a microcomputer, a microcontroller, a digital signal processor, a central processing unit (CPU), a graphics processing unit (GPU), a security processor etc. Alternatively, or in addition, some or all of the techniques described herein can be performed, at least in part, by one or more hardware logic components. For example, and without limitation, illustrative types of hardware logic components that can be used include a Field-Programmable Gate Array (FPGA), an Application-Specific Integrated Circuit (ASIC), an Application-Specific Standard Products (ASSP), a state machine, a Complex Programmable Logic Device (CPLD), other logic circuitry, a system on chip (SoC), and/or any other devices that perform operations based on instructions. Among other capabilities, the processor(s) may be configured to fetch and execute computer-readable instructions stored in the memory 710.

The memory 710 can include one or a combination of computer-readable media. As used herein, “computer-readable media” includes computer storage media and communication media.

Computer storage media includes volatile and non-volatile, removable and non-removable media implemented in any method or technology for storage of information, such as computer-readable instructions, data structures, program modules, or other data. Computer storage media includes, but is not limited to, phase change memory (PCM), static random-access memory (SRAM), dynamic random-access memory (DRAM), other types of random-access memory (RAM), read-only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, or any other medium that can be used to store information for access by a computing device.

In contrast, communication media includes computer-readable instructions, data structures, program modules, or other data in a modulated data signal, such as a carrier wave. As defined herein, computer storage media does not include communication media.

The host system 702 can communicate over the network 704 via network interfaces 718. The network interfaces 718 can include various types of network hardware and software for supporting communications between two or more devices. The host system 702 may also include machine learning model 719.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The disclosure presented herein also encompasses the subject matter set forth in the following clauses:

Clause 1: A method of identifying conditions in a virtualized computing environment providing a telecommunications network running a plurality of network functions, the method comprising, the method comprising:
receiving, by a computing system, data collected from the telecommunications network, wherein the data comprises test data from tests executed in the telecommunications network or live production data from the telecommunications network;
inputting the collected data to a first artificial intelligence (AI) model to identify a network function (NF) type indicated by the collected data;
based on the identified NF type, using a second AI model to generate a prompt for input to a generative pre-trained transformer (GPT) model, wherein the prompt is usable to identify a condition in the telecommunications network, the condition related to the NF type;
inputting the prompt to the GPT model to identify the condition in the telecommunications network, wherein the GPT model is trained with 3rd Generation Partnership Project (3GPP) documentation to provide telecommunications design and requirements knowledge to perform root cause analysis and generate recommendations related to performance and system functionality in the telecommunications network; and
initiating an action at the telecommunications network based on the identified condition.

Clause 2: The method of clause 1, further comprising parsing, editing, and organizing the collected data to generate a machine-readable structured format.

Clause 3: The method of any of clauses 1-2, further comprising concatenating tables to spatially map the collected data.

Clause 4: The method of any of clauses 1-3, wherein the first AI model is further used to identify telemetry information, wherein the telemetry information is further used by the second AI model to generate the prompt.

Clause 5: The method of any of clauses 1-4, wherein the telemetry information comprises one or more of events, metadata, tags, error messages, or metrics.

Clause 6: The method of any of clauses 1-5, wherein the first AI model comprises a classification model.

Clause 7: The method of clauses 1-6, wherein the classification model comprises a decision tree, K-nearest neighbor, multi-class SVM, or a convolutional neural network.

Clause 8: The method of any of clauses 1-7, wherein the first AI model is a natural language processing (NLP) model.

Clause 9: The method of any of clauses 1-8, wherein the NLP model as a Named Entity Recognition (NER) model trained with datasets of NF names and NF descriptions.

Clause 10: The method of any of clauses 1-9, wherein the network functions comprise MME, UPF, SMF, PGW, or SGW.

Clause 11: The method of any of clauses 1-10, wherein the first AI model comprises a plurality of recognition models for each network function.

Clause 12: The method of any of clauses 1-11, wherein the input to the second AI model further comprises, for each NF type:
a log type and data associated with the log type; and
log content extracted for each log type.

Clause 13: The method of any of clauses 1-12, wherein the prompt is appended with a context extracted by the second AI model.

Clause 14: A computing system, comprising:
one or more processors; and
a computer-readable storage medium having computer-executable instructions stored thereupon which, when executed by the processor, cause the computing system to perform operations comprising:
receiving, by a computing system, data collected from a telecommunications network, wherein the data comprises test data from tests run in the telecommunications network or live production data from the telecommunications network;
based on the collected data, using a first artificial intelligence (AI) model to identify a network function (NF) type;
based on the NF type, using a second AI model to generate a prompt for a generative pre-trained transformer (GPT) model; and
inputting the prompt to the GPT model to identify a condition in the telecommunications network, wherein the GPT model is trained with 3rd Generation Partnership Project (3GPP) documentation to provide telecommunications design and requirements knowledge to perform root cause analysis and generate recommendations related to performance and system functionality in the telecommunications network.

Clause 15: The computing system of clause 14, wherein the first AI model is further used to identify telemetry information, and wherein the telemetry information is further used by the second AI model to generate the prompt.

Clause 16: The computing system of any of clauses 14 and 15, wherein the first AI model comprises a classification model.

Clause 17: A computer-readable storage medium having computer-executable instructions stored thereupon which, when executed by a processor of a computing system, cause the computing system to perform operations comprising:
receiving, by a computing system, data collected from a telecommunications network, wherein the data comprises test data from tests run in the telecommunications network or live production data from the telecommunications network;
based on the collected data, using a first artificial intelligence (AI) model to identify a network function (NF) type;
based on the NF type, using a second AI model to generate a prompt for a generative pre-trained transformer (GPT) model; and
inputting the prompt to the GPT model to identify a condition in the telecommunications network, wherein the GPT model is trained with 3rd Generation Partnership Project (3GPP) documentation to provide telecommunications design and requirements knowledge to perform root cause analysis and generate recommendations related to performance and system functionality in the telecommunications network.

Clause 18: The computer-readable storage medium of clause 17, wherein the first AI model is a natural language processing (NLP) model.

Clause 19: The computer-readable storage medium of any of clauses 17 and 18, wherein the first AI model comprises a plurality of recognition models for each network function.

Clause 20: The computer-readable storage medium of any of the clauses 17-19, wherein the input to the second AI model further comprises, for each NF type:
a log type and data associated with the log type; and
log content extracted for each log type.

What is claimed is:

1. A method of identifying conditions in a virtualized computing environment providing a telecommunications network running a plurality of network functions, the method comprising:
receiving, by a computing system, data collected from the telecommunications network, wherein the data comprises test data from tests executed in the telecommunications network or live production data from the telecommunications network;
inputting the collected data to a first artificial intelligence (AI) model to identify a network function (NF) type indicated by the collected data;
based on the identified NF type, using a second AI model to generate a prompt for input to a generative pre-trained transformer (GPT) model, wherein the prompt is usable to identify a condition in the telecommunications network, the condition related to the NF type;
inputting the prompt to the GPT model to identify the condition in the telecommunications network, wherein the GPT model is trained with 3rd Generation Partnership Project (3GPP) documentation to provide telecommunications design and requirements knowledge to perform root cause analysis and generate recommendations related to performance and system functionality in the telecommunications network; and
initiating an action at the telecommunications network based on the identified condition.

2. The method of claim 1, further comprising parsing, editing, and organizing the collected data to generate a machine-readable structured format.

3. The method of claim 2, further comprising concatenating tables to spatially map the collected data.

4. The method of claim 1, wherein the first AI model is further used to identify telemetry information, wherein the telemetry information is further used by the second AI model to generate the prompt.

5. The method of claim 4, wherein the telemetry information comprises one or more of events, metadata, tags, error messages, or metrics.

6. The method of claim 1, wherein the first AI model comprises a classification model.

7. The method of claim 6, wherein the classification model comprises a decision tree, K-nearest neighbor, multi-class SVM, or a convolutional neural network.

8. The method of claim 7, wherein the first AI model is a natural language processing (NLP) model.

9. The method of claim 8, wherein the NLP model as a Named Entity Recognition (NER) model trained with datasets of NF names and NF descriptions.

10. The method of claim 1, wherein the network functions comprise MME, UPF, SMF, PGW, or SGW.

11. The method of claim 1, wherein the first AI model comprises a plurality of recognition models for each network function.

12. The method of claim 1, wherein the input to the second AI model further comprises, for each NF type:
a log type and data associated with the log type; and
log content extracted for each log type.

13. The method of claim 7, wherein the prompt is appended with a context extracted by the second AI model.

14. A computing system, comprising:
one or more processors; and
a computer-readable storage medium having computer-executable instructions stored thereupon which, when executed by the processor, cause the computing system to perform operations comprising:
receiving, by a computing system, data collected from a telecommunications network, wherein the data comprises test data from tests run in the telecommunications network or live production data from the telecommunications network;
based on the collected data, using a first artificial intelligence (AI) model to identify a network function (NF) type;
based on the NF type, using a second AI model to generate a prompt for a generative pre-trained transformer (GPT) model; and
inputting the prompt to the GPT model to identify a condition in the telecommunications network, wherein the GPT model is trained with 3rd Generation Partnership Project (3GPP) documentation to provide telecommunications design and requirements knowledge to perform root cause analysis and generate recommendations related to performance and system functionality in the telecommunications network.

15. The computing system of claim 14, wherein the first AI model is further used to identify telemetry information, and wherein the telemetry information is further used by the second AI model to generate the prompt.

16. The computing system of claim 14, wherein the first AI model comprises a classification model.

17. A computer-readable storage medium having computer-executable instructions stored thereupon which, when executed by a processor of a computing system, cause the computing system to perform operations comprising:
receiving, by a computing system, data collected from a telecommunications network, wherein the data comprises test data from tests run in the telecommunications network or live production data from the telecommunications network;
based on the collected data, using a first artificial intelligence (AI) model to identify a network function (NF) type;
based on the NF type, using a second AI model to generate a prompt for a generative pre-trained transformer (GPT) model; and
inputting the prompt to the GPT model to identify a condition in the telecommunications network, wherein the GPT model is trained with 3rd Generation Partnership Project (3GPP) documentation to provide telecommunications design and requirements knowledge to perform root cause analysis and generate recommendations related to performance and system functionality in the telecommunications network.

18. The computer-readable storage medium of claim 17, wherein the first AI model is a natural language processing (NLP) model.

19. The computer-readable storage medium of claim 18, wherein the first AI model comprises a plurality of recognition models for each network function.

20. The computer-readable storage medium of claim 19, wherein the input to the second AI model further comprises, for each NF type:
a log type and data associated with the log type; and
log content extracted for each log type.
